(19) United States
(12) Patent Application Publication
(10) Pub. No.: US 2008/0224837 A1
(43) Pub. Date: Sep. 18, 2008

(54) Method and Warning Device for Graphically Processing an Image of a Camera

(76) Inventors: Thorsten Meyer, Bietigheim-Bissingen (DE); Markus Hedderich, Stuttgart (DE); Juergen Benz, Besigheim (DE)

Correspondence Address: DREISS, FUHLENDORF, STEIMLE & BECKER, POSTFACH 10 37 62, D-70032 STUTTGART, DE

(21) Appl. No.: 10/589,566

(22) PCT Filed: Jan. 13, 2005
(86) PCT No.: PCT/EP05/00239

§ 371 Date: Aug. 16, 2006

(30) Foreign Application Priority Data
Feb. 23, 2004 (DE) 10 2004 009 924.3

(51) Int. Cl. B60Q 1/00

(52) U.S. Cl. 340/435

(57) ABSTRACT

The invention relates to a method for graphically processing an image of the surroundings of a motor vehicle, the image being been provided by a camera device. It is known fact that said images are processed in such a way that the danger potential for the motor vehicle posed by an obstacle in the surroundings is visualized optically by or highlighted for the driver. According to the invention, the image provided by the camera device is processed taking into account the position of the obstacle in the image in order to highlight said danger potential in an even clearer manner for the driver. To this end, the actual position of the obstacle in the surroundings of the motor vehicle is initially determined. The position of the obstacle in the image corresponding to the actual position of the obstacle in the surroundings is subsequently determined.

The invention concerns a method and a computer program for graphically processing an image, provided by a camera device, of the surroundings of a vehicle, in particular in the direction of motion of the vehicle. The invention also concerns a warning device for carrying out this method and a data carrier comprising the computer program.

Methods and warning devices of the above-mentioned type are known in the art. Such warning devices typically comprise a camera device which is installed e.g. in the rear of a vehicle, in order to detect the surroundings of the vehicle in the rear area. An image recorded by this camera device is typically processed using an image processing means, and displayed to the driver on a display means in the dashboard. The driver can use the displayed image for backing up the vehicle.

In order to assist the driver's orientation when backing up, graphical objects are conventionally introduced into the image provided by the camera device during processing, which show the driver the expected course of motion of the vehicle while backing up. This course of motion is conventionally determined on the basis of the instantaneous steering angle.

The quality of the image provided by the camera device is, however, often quite poor. In particular, in dark weather, rain or fog, obstacles which might be present in the surroundings of the vehicle are often not clearly visible. For this reason, the driver often cannot realistically assess the danger that such obstacles in the surroundings of the vehicle might represent to the vehicle.

Departing from this prior art, it is the underlying purpose of the invention to further develop a conventional method and a computer program for graphically processing an image, provided by a camera device, of the surroundings of a vehicle, as well as a warning device to perform this method, in such a manner that the danger to the vehicle in the form of an obstacle that might be present in the surroundings of the vehicle, is presented to the observer of the processed image, i.e. in particular the driver of the vehicle, in a more realistic and clearer form.

This object is achieved by the method claimed in claim 1. This method is characterized by the following steps: detection of an obstacle in the surroundings of the vehicle and determination of its real position, preferably relative to the position of the vehicle, detection of the real position of the obstacle in the surroundings and the corresponding position of the obstacle in the image provided by the camera device, and processing the image thereby taking into consideration the determined position of the obstacle in the image.

In order to understand the present invention, it is important to distinguish between the image provided by the camera device, graphical processing of this image, and the processed image resulting from this processing. The observer, in particular, the driver of the vehicle can, in principle, only see the processed image.

It is also important to distinguish between the objects which really exist in the surroundings of the vehicle, such as, in particular, obstacles for the vehicle, which are shown on the image provided by the camera device, and the imaginary graphical objects which are artificially generated within the scope of image processing and which are explained in more detail below.

The claimed method advantageously automates the process of detecting danger to the vehicle and therefore also to the driver in the form of an obstacle that might be present in the surroundings of the vehicle. The camera device alone, cannot realize this. It illustrates the surroundings of the vehicle in an image in a neutral fashion, i.e. without assessment. “Without assessment” in this connection means that the camera device itself does not know which parts of the image detected thereby represent an obstacle in the surroundings of the vehicle and which do not. To a still greater extent, the camera device is incapable of assessing the danger that this obstacle could represent to the vehicle.

In accordance with the invention, the real position of the obstacle in the surroundings of the vehicle, preferably relative to the position of the vehicle or the position of the camera device, is initially detected in order to detect which parts of the image recorded by the camera device represent an obstacle for the vehicle. This is achieved in accordance with the invention by means of an obstacle detection or distance measuring device which is based e.g. on ultrasound, radar or camera/image analysis methodology. The present invention uses such a device in addition to the camera device. In accordance with the invention, the real position of the obstacle in the surroundings of the vehicle thereby detected is then converted into the corresponding position of the obstacle in the image provided by the camera device using suitable mathematical algorithms or transformations. The real position of the obstacle in the surroundings is generally a three-dimensional value, whereas the position of the obstacle in the image is a two-dimensional value. The e.g. three-dimensional position is therefore converted into a two-dimensional position through corresponding transformations.

In accordance with the invention, the image provided by the camera device is processed using information concerning the previously detected position of the obstacle in the camera device image. Based on this information, the image can be processed precisely for the observer, in particular, the driver of the vehicle, such that he/she will be given concrete information about the obstacle itself, and also concerning the danger to the vehicle represented by this obstacle, e.g. in the form of the distance between the vehicle and the obstacle.

In a particularly simple realization of the inventive method, it is advantageously sufficient to determine the position of the obstacle relative to the vehicle or the camera device in one dimension only, i.e. in the form of the corresponding distance.

In order to assist the driver's orientation in the surroundings detected by the camera device, a graphical object, in the form of the expected future course of motion of the vehicle, is advantageously faded into the image of the camera device while processing the camera device image. In accordance with the invention, the graphical object is only faded-in at regions of the image provided by the camera device, which show no obstacle, in order not to confuse or irritate the driver. The distance between the obstacle and the vehicle detected in accordance with the invention is advantageously used to delimit the faded-in course of vehicle motion, such that the graphical object does not overlap the obstacle shown in the image. As an alternative to such total limitation, the course of motion of the vehicle at the approximate predetermined position of the obstacle may be represented only schematically in the image, e.g. in the form of dashed lines for large distances from the vehicle.

The obstacle detection or distance measuring devices usually not only measure distances but generally also determine a second and/or third dimension of the position of the obstacle in the spatial surroundings, relative to the vehicle. It is thereby possible to determine the part or region of the surroundings of the vehicle, detected by such a device, in which the obstacle is located. The invention advantageously proposes a graphical object, in particular a bar, which permits transfer of information about the region in addition to the distance. All graphical objects presented within the scope of the invention are advantageously represented in a semi-transparent fashion or only as contour in order not to cover the parts of the image from the camera device located at the respective position of the graphical object. The graphical object may alternatively be designed to at least partially cover these parts. The graphical objects may then be represented as colored surfaces, wherein the colors can be optionally varied in accordance with the determined distance between the obstacle and the vehicle or the camera device.

Processing of the image provided by the camera device need not necessarily include fading-in or superposition of the graphical objects. Instead, selected parts of the image provided by the camera device may be directly manipulated, e.g. brightened up or colored. The selected parts are preferably those regions which represent the obstacle, as verified by the information provided from the obstacle detection or distance measuring device. The direct manipulations of the image provided by the camera device, are also advantageously varied in color in accordance with the magnitude of the instantly detected distance between the obstacle and the vehicle.

The above-stated object of the invention is also achieved by a computer program and a warning device for a vehicle for performing the claimed method as well as by a data carrier comprising the above-mentioned computer program. The advantages of these solutions correspond to the advantages mentioned above with reference to the claimed method.

Seven figures accompany the description.

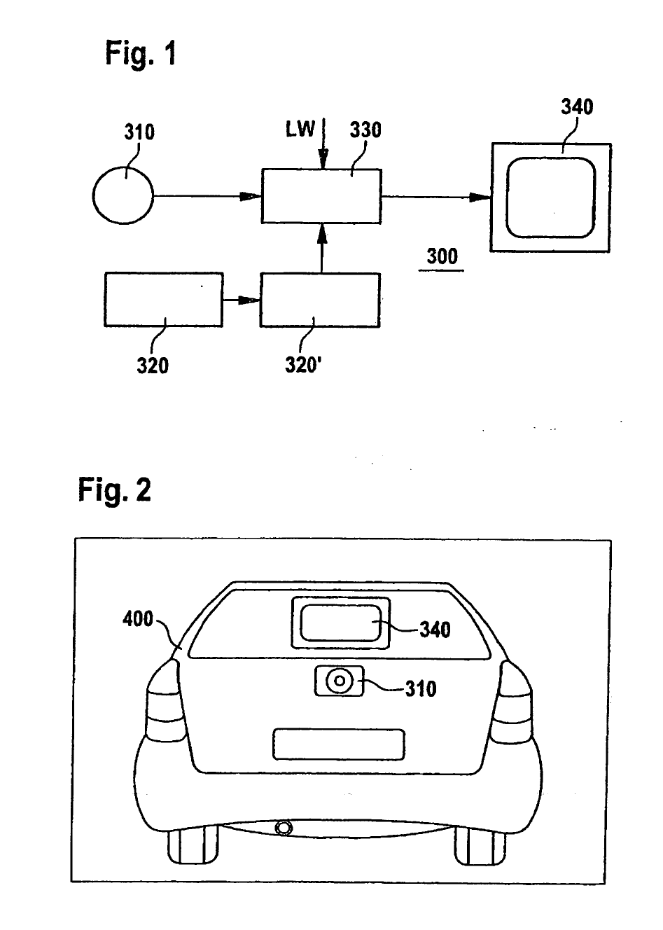

FIG. 1 shows the warning device in accordance with the invention;

FIG. 2 shows installation of the warning device into a vehicle;

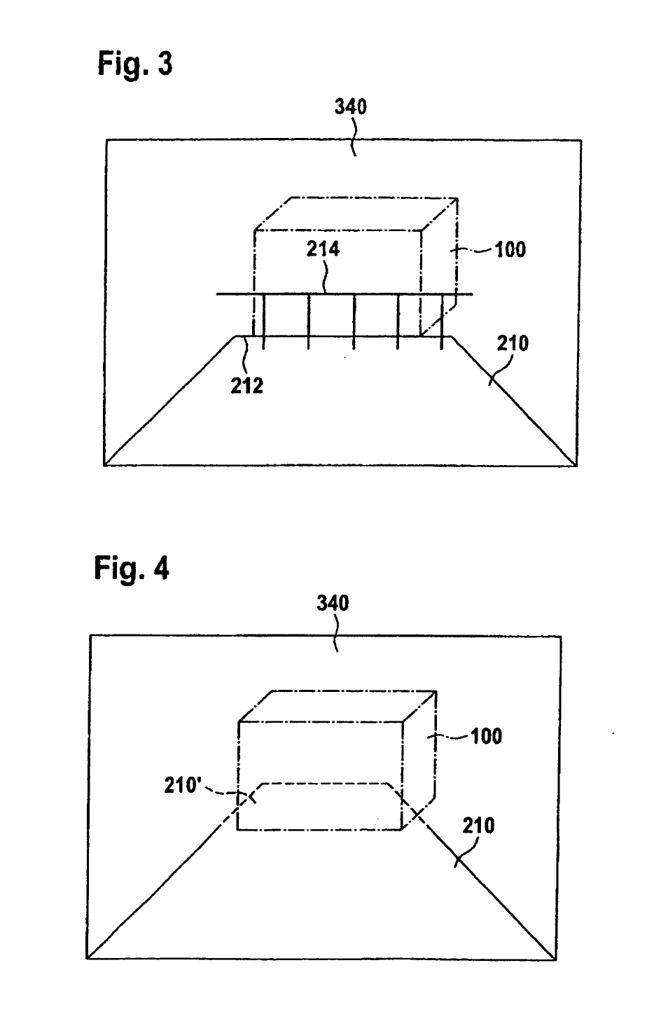

FIG. 3 shows a first embodiment of the inventive method,

FIG. 4 shows a second embodiment of the inventive method;

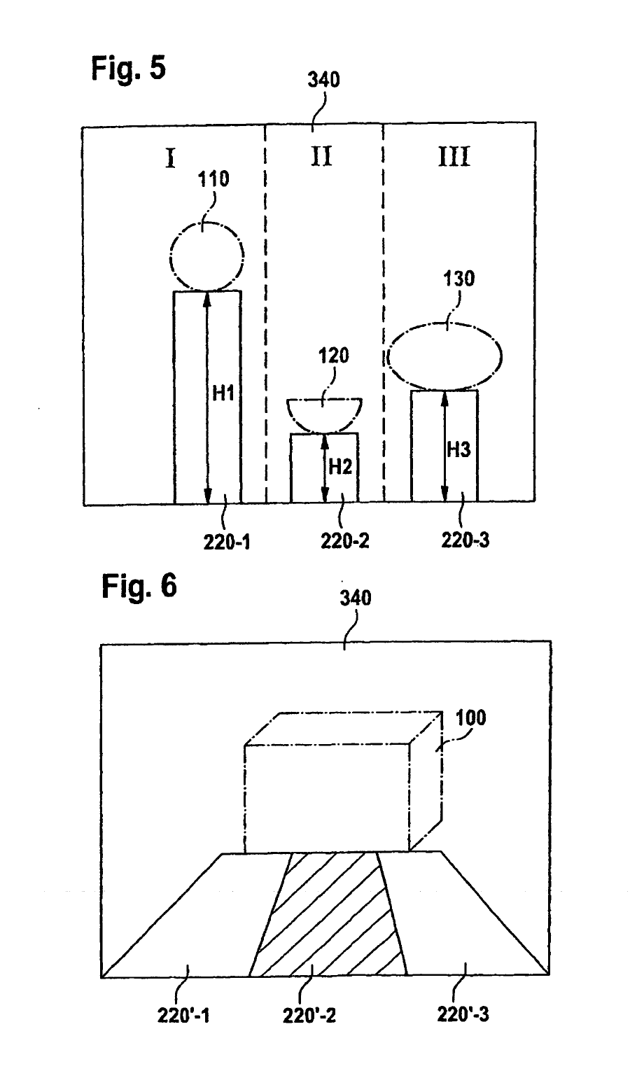

FIG. 5 shows a third embodiment of the inventive method;

FIG. 6 shows a fourth embodiment of the inventive method; and

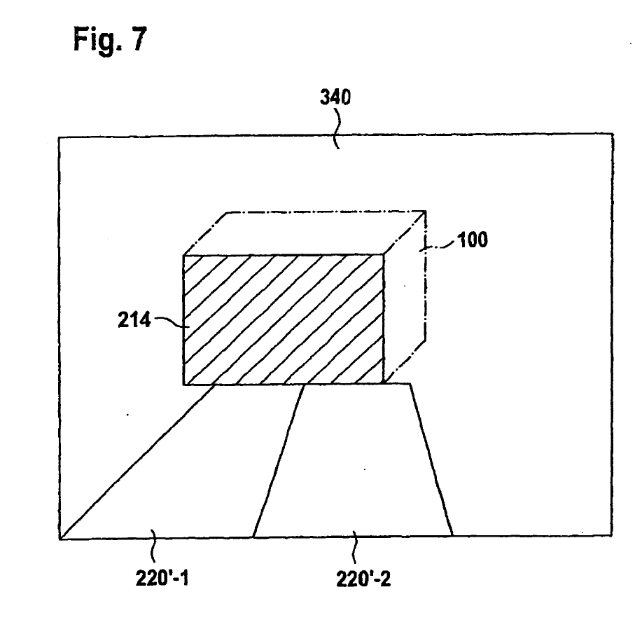

FIG. 7 shows a fifth embodiment of the inventive method.

The invention is described in more detail below by means of embodiments with reference to the above-mentioned figures.

FIG. 1 shows the structure of a warning device 300 in accordance with the invention for a vehicle 400 (FIG. 2). The warning device 330 comprises a camera device 310 for generating images of the surroundings of the vehicle 400, preferably in the direction of travel. The warning device 300 also comprises an image processing device 330 disposed downstream of the camera device 310 for processing the images produced by the camera device 310. The warning device 300 also comprises an obstacle detection/distance measuring device 320 which determines, in particular, the real position of an obstacle 100, which may be present in the surroundings of the vehicle 400, relative to the position of the vehicle 400. The warning device 300 also comprises a transformation means 320′ for transforming the real position of the obstacle 100 in the surroundings, detected by the obstacle detection/distance measuring means 320, into a corresponding position of the obstacle in the image provided by the camera device. The image processing device 330 is designed in accordance with the invention in order to process the image provided by the camera device 310, thereby taking into consideration the previously detected position of the obstacle 100 in the image. The image processing device 330 is moreover designed to process the image, thereby also taking into consideration vehicle parameters, in particular, the steering angle. The image processed by the image processing device 330 is finally displayed to a viewer, in particular the driver of the vehicle, on a display means 340.

FIG. 2 shows that this display means 340 is preferably disposed in the visual range of the driver of the vehicle 400. In contrast thereto, the camera device 310 is preferably disposed in the rear region of the vehicle 400 to detect the surroundings of the vehicle 400, in particular, when backing up.

The following FIGS. 3 through 7 show different embodiments of processed images which can optionally be displayed in the display means 340. The real objects shown in the image provided by the camera device 310, in particular the obstacle 100, are shown with dash-dotted lines, while the graphical objects artificially faded into the image during processing are shown with solid or dashed lines. In each figure, the lower edge of the image substantially represents the position of the vehicle or the camera device 310.

FIG. 3 shows a first embodiment of a processed image. This image is prepared by a graphical object 210 which represents the expected future course of motion of the vehicle 400. The graphical object 210 of FIG. 3 shows a straight course of motion of the vehicle which is determined, in particular, through evaluation of the instantaneous steering angle. This graphical object 210 or the course of motion of the vehicle which it represents is advantageously delimited at the level of the position of the obstacle 100. The height or length of the graphical object, measured from the lower edge of the image, represents the distance between the obstacle 100 and the vehicle 400 determined by the obstacle detection/distance measuring device 330.

The limitation is advantageously in the form of a limiting line 212 and/or an additional further graphical object 214 which represents a limiting means such as e.g. a barrier, a gate or a fence. In this case, superposition of the graphical object 210 and the obstacle 100 can, by way of exception, be accepted without excessively confusing the driver. However, such superposition should generally be avoided. The limiting line 212 and/or the limiting means 214 illustrate danger of collision represented by the obstacle 100 with great clarity to the viewer of the image, in particular the driver of the vehicle. He/she can see that driving the vehicle beyond the limit will unavoidably cause a collision with the obstacle 100.

FIG. 4 shows a second embodiment of the design of the graphical object 210 representing the course of motion of the vehicle. In contrast to FIG. 3 which does not show the course of motion beyond the limit 212, 214, it may thereby be advantageous to represent the course of motion beyond this limit, i.e. at larger distances from the vehicle 400, using dashed lines (reference numeral 210′). The first embodiment of FIG. 3 can, of course, be combined with the second embodiment of FIG. 4.

Only the distance between the obstacle 100 and the vehicle 400 must be known in order to correctly position the limit mentioned in the description of FIG. 3, i.e. preferably at the side 110 of the obstacle 100 facing the camera device 310 or closest thereto. It is, however, often also possible to determine the region of the detected space, in which the obstacle 100 is located, by using the obstacle detection/distance measuring device 320. This permits distinguishing whether an obstacle is located substantially on the left-hand side of the camera device 320, in front of or on the right-hand side of the device 320. These three possible regions are designated in FIG. 5 by reference numerals I, II, and III. Clearly, suitable design of the respective obstacle detection/distance measuring device also permits a finer or less fine subdivision of the regions. In order to not only provide the viewer of the processed image with information about the distance between the obstacle and the vehicle 400 but also with information about the region where the obstacle is located, the invention proposes to fade a suitable graphical object into the image provided by the camera device 310, which characterizes and optically emphasizes the respective region I, II or III and the position of the obstacle within this region for the observer of the processed image. FIG. 5 shows this graphical object in the form of bars 220-1 . . . -3, preferably extending from the lower edge of the image in a vertical direction, for the individual detection regions or regions I, II and III. The reference numerals I, II and III and the vertical dashed lines of FIG. 5 which indicate the mutual limits of the regions are preferably not shown in the processed image. The horizontal positioning of the vertical bars relative to the position of the camera device in the center of the lower edge of the image shows the viewer whether a bar indicates an obstacle 110 in the left-hand region I, such as bar 220-1, or an obstacle 120 in the center of the observed region II, such as bar 220-2, or an obstacle 130 in the right-hand region III, such as bar 220-3. The heights or lengths H1, H2, H3 of the bars 220-1, 220-2 and 220-3 represent the distance between the obstacle 110, 120, 130 and the vehicle 400 (not shown in FIG. 5) determined in each case by the distance measuring device 320.

FIG. 6 shows a fourth embodiment of a processed image. In contrast to the bars of FIG. 5, the contours of the bars 220′-1 . . . -3 are herein adjusted to the direction of motion determined by the image processing device 320 on the basis of the steering angle LW, and are correspondingly bent or distorted. As in FIG. 5, the height or length of the bars 220′-1, . . . -3 represents the distance between the obstacle 100 and the vehicle 400 or the camera device 310. The fact that FIGS. 5 and 6 each show bars for all three regions I, II, and III means that either an obstacle 100 is present which projects into all three regions (FIG. 6) or different obstacles 110, 120 and 130 are present in the different regions I, II and III. When no obstacle is detected in one region, this region should preferably not have any graphical object, in particular, no bar 220.

It was mentioned above that an obstacle represented in the image provided by the camera device 310 should advantageously not be superposed by an artificially inserted graphical object. As an exception, it is possible to provide graphical objects 214 at the position of the obstacle 100 in the image provided by the camera device 310 in accordance with the invention. These graphical objects preferably optically emphasize, to the viewer, that region or that side of the obstacle 100 which faces the camera device. FIG. 7 shows such a graphical object 214. The outline of this graphical object 214 thereby accidentally corresponds exactly to the contour of the side of the obstacle 100 which faces the camera device. Alternatively, the outline of such a graphical object may basically have any design, preferably a geometrical basic shape, such as e.g. a rectangle, an ellipse or a triangle. All graphical objects mentioned within the scope of the invention are preferably shown in a semi-transparent fashion or only as an outline, in order not to unnecessarily cover the image provided by the camera device 310. The graphical objects may alternatively be designed as a colored surface, wherein the colors may be varied in accordance with the determined distance between the obstacle 100 and the vehicle 400 or the camera device 310. It is e.g. feasible to mark the graphical object red when the distance is smaller than a predetermined first lower threshold distance, to mark it yellow when the distance is between the first lower and a second threshold distance, and green for a distance beyond the second threshold distance.

Clearly, all above-mentioned variations of the graphical objects can be realized in any combination which does not result in mutual exclusion.

The driver of the vehicle 400 who observes the processed image may be informed of the danger of collision not only by the above-mentioned design variants of the graphical objects. Furthermore or in combination with the graphical objects, the image provided by the camera device 310 may be directly manipulated e.g. by brightening or coloring. As described above in connection with the graphical objects, such manipulation also offers the optional possibility to vary the manipulation in accordance with the magnitude of the determined distance between the obstacle 100 and the vehicle, e.g. in the form of color or flashing effects.

The inventive method is preferably realized in the form of a computer program. Such a computer program may be optionally stored together with further computer programs on a computer-readable data carrier. The data carrier may be a disc, a compact disc, a flash memory or the like. The computer program stored on the data carrier may then be transferred or sold as a product to a customer. As an alternative to transfer via data carrier, it may also be transferred via an electronic communications network, in particular, the Internet.

1-17. (canceled)

18. A method for graphically processing an image, provided by a camera device, of surroundings of a vehicle or in a direction of travel of the vehicle for presentation to an observer or to a driver of the vehicle, the method comprising the steps of:
a) detecting an obstacle in the surroundings of the vehicle;
b) determining a position of the obstacle relative to a position of the vehicle;
c) determining a position of the obstacle relative to the surroundings;
d) determining a position of the obstacle in the image provided by the camera device; and
e) processing the image thereby taking into consideration the determined position of the obstacle in the image.

19. The method of claim 18, wherein a graphical object illustrating an expected future course of travel of the vehicle is faded into the image of the camera device and the position of the obstacle in the surroundings is determined using the known distance between the obstacle and the vehicle or the camera device, wherein the position of the obstacle in the image or of a side of the obstacle facing or closest to the camera device, represents the determined actual distance between the obstacle and the camera device.

20. The method of claim 18, wherein the expected future course of travel is determined using information concerning a steering angle of the vehicle and a fictitious camera position is illustrated in a lower portion of the image.

21. The method of claim 19, wherein the graphical object which is faded into the image of the camera device to illustrate the course of travel comprises a symbol indicating an end of travel motion, the symbol being a limiting line, limiting means symbolically presented on the course of travel, a barrier, a gate, or a fence disposed approximately at a level of the determined position of the obstacle in the image.

22. The method of claim 19, wherein the graphical object illustrating the course of travel is imaged only to approximately a level of the determined position of the obstacle in the image, but not for larger distances from the vehicle or the camera device.

23. The method of claim 19, wherein for large separations from the vehicle beyond an approximate location of the determined position of the obstacle in the image, the graphical object in the form of the course of travel is only schematically indicated or is indicated using broken lines.

24. The method of claim 18, wherein, as viewed by the camera device, at least one region of the surroundings of the vehicle is determined in which the obstacle is located and at least one graphical object is faded into the image of the camera device to optically emphasize a correlation between the obstacle and the at least one region and/or a position of the obstacle within this region.

25. The method of claim 24, wherein a bar or a bar which extends in a vertical direction from a lower edge of the image is faded into the image as the graphical object to indicate the position of the obstacle relative to the position of the vehicle or the camera device, wherein a horizontal position of the bar in the image represents the region of the surrounding and/or a height or length of the bar in a vertical direction represents the determined distance between the obstacle and the vehicle.

26. The method of claim 25, wherein an outline of the bar is adjusted to the representation of the determined course of travel and is illustrated in a correspondingly bent and/or distorted fashion.

27. The method of claim 18, wherein a graphical object is faded into the image at the position of the obstacle in the image or at a position of a side of the obstacle facing or closest to the camera device, wherein the obstacle is at least partially covered.

28. The method of claim 27, wherein the outline of the graphical object has a basic geometric form, is rectangular, oval, triangular or has a form of a determined outline of the obstacle.

29. The method of claim 19, wherein the graphical object is semi-transparent or represented only as an outline.

30. The method of claim 19, wherein the graphical object is represented as a colored surface, wherein a color can optionally be varied in accordance with the determined distance between the obstacle and the vehicle or the camera device.

31. The method of claim 18, wherein the image of the camera device is manipulated, brightened, or colored in a region of the determined position of the obstacle, wherein the manipulation depends on a magnitude of the determined distance between the obstacle and the vehicle, varies in time and/or flashes.

32. A computer program comprising a program code for a vehicle warning device, wherein the program code is designed to perform the method of claim 18.

33. A data carrier having the computer program of claim 32.

34. A warning device for a vehicle, comprising:
a camera device for generating images of surroundings of the vehicle or in a direction of vehicle travel;
an image processing device for processing the images produced by the camera device;
a display means for displaying the processed image to a viewer or to a driver of the vehicle;
an obstacle detection/distance measuring device for detecting an obstacle in the surroundings of the vehicle and for determining a real position of the obstacle;
a transformation device for transforming the real position of the obstacle in the surroundings into a corresponding position of the obstacle in the image of the camera device; and
means, within said image processing device, for processing the image of the camera device, thereby taking into consideration the determined position of the obstacle in the image.

35. The warning device of claim 34, wherein the image processing device is designed to process the image of the camera device while taking into consideration vehicle parameters or a vehicle steering angle.
